(19) United States
(12) Patent Application Publication
(10) Pub. No.: US 2014/0290697 A1
(43) Pub. Date: Oct. 2, 2014

(54) Method for Testing and Cleaning a Pipeline

(71) Applicant: Michael H. James, Lottie, LA (US)

(72) Inventor: Michael H. James, Lottie, LA (US)

(21) Appl. No.: 14/242,639

(22) Filed: Apr. 1, 2014

Related U.S. Application Data
(60) Provisional application No. 61/807,207, filed on Apr. 1, 2013.

(51) Int. Cl. B08B 9/055; B08B 9/032

(52) U.S. Cl. CPC B08B 9/055; B08B 9/0322
USPC 134/8; 15/3.5

(57) ABSTRACT

A pipeline cleaning apparatus and method configured for use in cleaning and clearing a pipeline of transient fluids, hydrocarbons, and other unwanted debris is disclosed. The apparatus and method utilizes a vacuum assembly haying a collection tank connected to a pipeline by at temporary vacuum line. Negative pressure created by the vacuum assembly causes a compressible pig to move down the length of the pipeline and up the temporary vacuum line to push transient hydrocarbons, fluids, and other unwanted debris from within the pipeline to the collection tank. The removal of hydrocarbons and non-hydrocarbons from the pipeline cleans the pipeline and allows the pipeline to be abandoned while complying with federal regulations.

### PRIORITY

This application claims priority to U.S. provisional application Ser. No. 61/807.207 filed Apr. 1, 2013 entitled “Method of Testing & Cleaning a Pipeline”, the entire content of which is hereby incorporated by reference.

### FIELD OF THE INVENTION

This invention relates to a method for cleaning an abandoned pipeline. More particularly, this invention relates to the testing and removal of transient hydrocarbons and other materials from an abandoned or soon to be abandoned pipeline.

### BACKGROUND

To comply with federal regulations, oil and gas pipelines, whether offshore or onshore, must be cleaned of transient hydrocarbons and tested for leaks prior to being abandoned. The interior of the pipeline must be cleaned and the fluid therein must be drained or syphoned therefrom. Traditionally, pipelines were left on site after completion and termination of the well. Under new policy, the pipeline must be cleaned and sealed or capped, and the ground adjacent thereto must be remediated and returned to substantially similar conditions as prior to the drilling.

Wellbore cleaning devices typically include casing scrapers and brushing devices used to remove mud, cement, rust, scale, and other debris from the internal surface of the wellbore casing are sometimes used on pipelines. Such devices use abrasive blade or bristle snakes to scrape or brush against the interior surface of the wellbore to remove adhered materials which can cause structural damage to the integrity of the pipeline Such damage may provide a source for a leak in the pipeline wall not immediately apparent after cleaning and allow extravasation of uncleared fluid and hydrocarbons from the pipeline into the environment. Such extravasation of fluids and hydrocarbon which will lead to incurred cost of repairing the pipeline leak and recapturing the leaked fluids and hydrocarbons from the environment if possible.

Consequently, there is a need for a device and method for substantially cleaning a pipeline of adhered fluid and hydrocarbons without damaging the integrity of the pipeline and which allows for the simultaneous testing of the integrity of the pipeline, and if a pipeline leak has developed, for keeping the integrity of the non-damaged portion of the wellbore so that the leak may be located and repaired.

### SUMMARY OF THE INVENTION

The present invention provides a pipeline cleaning apparatus and method to simultaneously check a pipeline for leaks while the pipeline is cleaned and cleared of transient fluids and hydrocarbons, such as salt water, paraffin, waxes, and other solids and fluids that accumulate and buildup over time. The invention is comprised of a vacuum assembly creating a negative pressure on the interior of the pipeline and a compressible cleaning pig or similar device transported through the pipeline by the negative pressure provided by the Vacuum assembly. The vacuum assembly can have a. variety of configurations but will generally include a material handling apparatus having a collection tank, a vacuum pump for creating a vacuum in the collection tank, as connecting vacuum line from the collection tank to the pipeline, an entry into the pipeline for inserting the cleaning pig, and a discharge assembly to allow material drawn into the collection tank to be delivered to a desired location. Preferably the components of the vacuum assembly can be easily transported and setup on a job location.

The pipeline cleaning apparatus is assembled at the surface on a barge, a boat, or other floating vessel positioned adjacent to a pipeline or alternatively, positioned on the shore or a stationary platform proximate to the pipeline. A temporary vacuum line in communication with the collection tank is attached to the pipeline at a desired location on a segment of pipeline away from the surface. The vacuum pump of the vacuum assembly provides a negative pressure within the collection tank and the temporary vacuum line. The compressible pig, or other similar device is then inserted into the pipeline proximate the surface. As the negative pressure within the collection tank and the temporary line increases, a negative pressure is created in the pipeline causing the pig to move from the surface. downward through the pipeline toward the attached temporary vacuum line. As the pig moves though the pipeline, the action of the pig on the interior pipeline wall dislodges and removes paraffin, scale, rust, and other debris and transports the debris and any transient hydrocarbons and fluid down the pipeline, up the temporary line, and into the collection tank. The then clean pipeline is safe to be abandoned while complying with federal regulation.

The compressible pigs utilized in the pipeline cleaning apparatus are generally made of plastic, foam with smooth exterior surfaces, urethane, rubber or the like and are cylindrical or bullet shaped. The pigs may range from 1″ to 3″ larger in diameter than the inside diameter or I.D. of the pipeline to be cleaned. Compressing the pig and propelling it through the pipeline by the negative pressure will scrape away unwanted debris in the pipe line such as accumulated hydrocarbons, salt water, paraffin, and other solids and fluids that build up and accumulate within the pipeline.

An advantage of the present invention is that the pipeline can be cleaned of all transient hydrocarbons and non-hydrocarbons prior to be rig abandoned, allowing the abandoned pipeline to comply with federal regulations and guidelines.

A further advantage of the present invention is that the vacuum assembly can effectively check the pipeline for leaks and structural integrity. Any leaks in the pipeline must he sealed prior to abandonment to ensure safety of the environment. If a leak is present in the pipeline, the leak will result in a change in the negative pressure in the pipeline and will be apparent.

An additional advantage of the present invention is that as the pig moves through the pipeline it passes over the inner surface of the pipeline, scraping any non-hydrocarbons that may be contained therein.

### BRIEF DESCRIPTION OF THE DRAWINGS

FIG. 1 is a schematic view of the pipeline cleaning apparatus and method described herein configured for offshore pipelines.

FIG. 2 is a schematic view of an alternative embodiment of the pipeline cleaning apparatus and method of FIG. 1 where the pipeline is located near the shore.

FIG. 3 is a schematic view of the vacuum assembly of the pipeline cleaning apparatus and method depicted in FIG. 1 and FIG. 2.

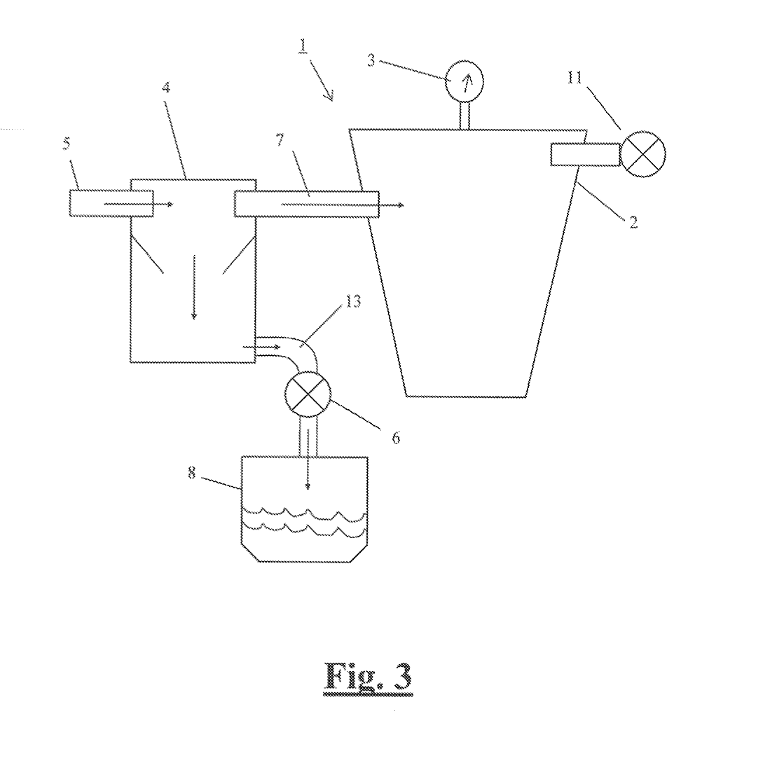

### DETAILED DESCRIPTION OF THE DRAWINGS

Unless otherwise specified, the illustrated embodiments can be understood as providing exemplary features of varying detail of certain embodiments, and therefore, unless otherwise specified, features, components, elements, and/or aspects of the drawings can be otherwise combined, interconnected, sequenced, separated, interchanged, positioned, and/or rearranged without materially departing from the herein disclosed invention. The elements illustrated in the drawings are provided primarily to facilitate understanding of the disclosed technology and are not necessarily drawn to scale or with precise accuracy. The drawings also omit, in the interest of descriptive clarity, elements such as pump motors, connection flanges, control valves, pressure relief valves, discharge valves, seals, and the like where the use of which is well known and obvious.

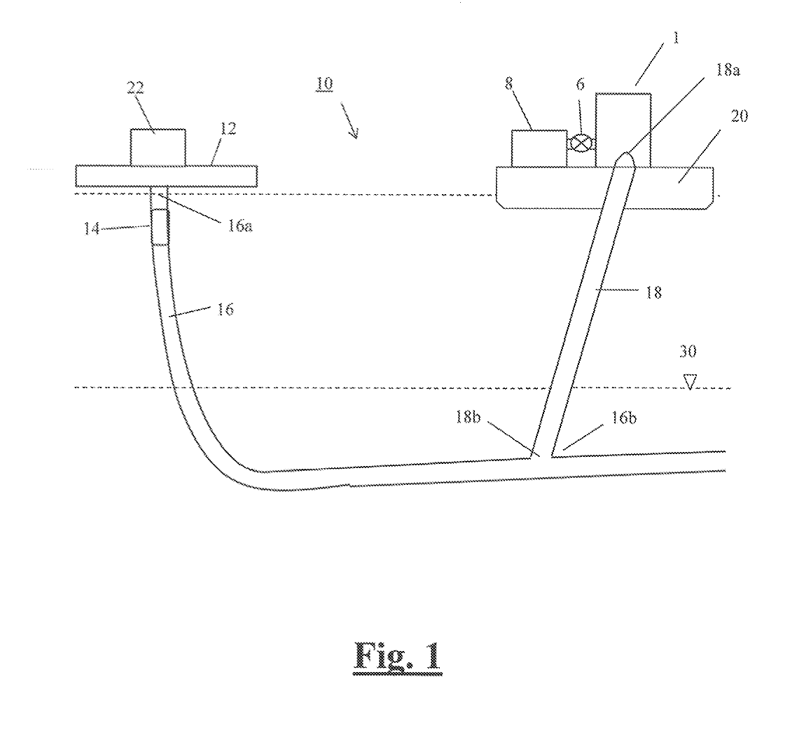

A schematic view of the pipeline cleaning apparatus (10) and method configured for use on an offshore pipeline (16) supported at platform (12) is shown in FIG. 1. Apparatus (10) is comprised of a vacuum assembly (1) and a compressible cleaning pig 14). The vacuum assembly (1) is positioned on a barge (20) or other supporting vessel. A temporary vacuum line (18) has a first connection inlet (18a) attached to the vacuum assembly (1) on barge (20) and a second connection inlet (18b) attached to pipeline inlet (16b) of a section of pipeline (16) to be cleaned and cleared. Typically pipeline (16) will have a segment located underground, i.e., below the mud line (30). Pig (14) is inserted into pipeline (16) at platform 12) at the top end (16a) of pipeline (16). The pig (14) will preferably be compressible and have an outer diameter equal to or slightly larger than the inner diameter of the pipeline (16) so that it will seal pipeline (16) at end (16a).

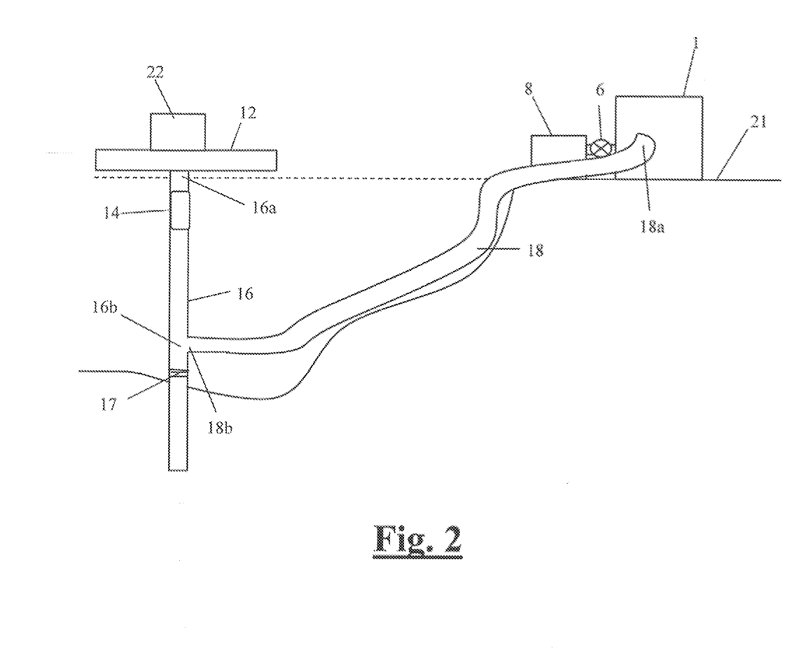

FIG. 2 shows a schematic view of a vacuum assembly (1) of the pipeline cleaning apparatus (10). Vacuum assembly (1) has a vacuum chamber (2) in communication with a vacuum pump (11), a debris collection tank (4). Collection tank (4) has a suction line (7) in communication with vacuum chamber (2), a suction inlet line (5) for attachment to connection inlet (18a) of temporary line: (18), and a discharge outlet line (13), The discharge outlet line (13) may be in communication with discharge pump (6) and storage container (8). Vacuum chamber (2) is provided with a pressure gauge (3) for monitoring chamber pressure and the suction provided at suction inlet line (5). While not shown in the drawings, vacuum chamber (2) and suction line (7) may also have one or more pressure relief valves or control valves and suction inlet line (5) and discharge line (13) may also be provided with valves to control the flow of material into and out of collection tank (4).

In an alternative embodiment of the pipeline cleaning apparatus (10) shown in FIG. 2. In a situation where pipeline (14) is located near or on the shore, vacuum assembly (1) can be positioned on the shore or ground (21) for attachment to temporary hue (18). If necessary to maintain negative pressure in the selected segment of pipeline (16) a valve or plug (17) may be placed in pipeline (16) at a point below inlet (16b) to seal and isolate the portion of pipeline (16) to be cleaned.

For use, vacuum chamber (2) of vacuum assembly (1) is negatively pressurized by means of a vacuum pump (11) or other suitable means of creating a negative pressure within the vacuum chamber (2), As the negative pressure in vacuum chamber (2) increases, a negative pressure is generated on the inlet (5) of collection tank (4). This negative pressure causes the vacuum to suck or create a pulling force on the temporary line (18) attached at inlet (5). This negative pressure will draw the pig (14) through pipeline (16) toward pipeline inlet (16b) where pig (14) will enter temporary vacuum line (18) spanning between pipeline (16) and inlet (5) of the vacuum assembly (1). Because the pig (14) is compressible, pig (14) will be in contact with and scrape the interior walls of the pipeline (16) and push unwanted debris scrapped from the pipeline walls or otherwise present in the pipeline (16) along with any transient hydrocarbons and fluid through the pipeline (16) up temporary line (18) towards the vacuum assembly (1). Transient hydrocarbons and fluid in line (18) are diverted into collection tank (4) and collected. The pig (14) will travel through temporary line (18) where it m he removed at the inlet (5) or at another convenient location having cleared pipeline (16) of hydrocarbons and other fluids and materials. When the unwanted debris material drawn into collection tank (4) from temporary line (18) reaches a desired volume limit, collection tank (4) may be delivered or discharged into storage container (8) through discharge line (13).

Unwanted debris material discharged from collection tank (4) through discharge line (13) may be by gravity flow or the materials from collection tank (4) may be moved to the storage container (8) by means of primp (6). The pump (6) can be a vacuum pump, a mechanical pump, a solids pump, or any other suitable pumping means. Once in he storage container (8), material can be transported from the barge (20) and delivered to an appropriate location for further handling or disposal.

In the event that the negative pressure generated by the vacuum assembly (1) is insufficient to draw or pull the pig (14) through the pipeline (16) and into temporary line (18), to blower (22) on platform (12) may be provided to apply positive pressure in line (18) behind pig (14) to assist in pushing the pig (14) through the pipeline (16). It is believed that positive pressure from blower (22) may be required to move pig (14) through pipeline (16) when pipeline (16) is located thirty feet or more in depth below mudline (30).

An advantage of the present invention is that it inherently checks the pipeline (16) for leaks and cracks. As the vacuum assembly (1) is utilized to provide a negative pressure in pipeline (16), any leaks or breaches within the pipeline (16) will become readily apparent by monitoring gauge (3). Any leaks within the pipeline (16) will prevent the vacuum chamber (2) from fully pressurizing and may prevent the vacuum (10) from pulling the pig (14) through the pipeline (16) towards the barge (20). Upon finding a leak within the pipeline (16), the pipeline (16) can be more closely inspected to locate and repair the leak.

If no leaks are present within the pipeline (16), the vacuum assembly (1) is utilized to induce a negative pressure in pipeline (16) via temporary vacuum line (18) to pull the pig (14), and any transient fluids, hydrocarbons, and other unwanted debris in pipeline (16), down the length of the pipeline (16) through temporary line (18) towards the barge (20) and into collection tank (4) where they are collected prior to ultimate disposal, thereby clearing and cleaning pipeline (16).

I claim:

1. A method for cleaning a pipeline comprising the steps of:
a. providing a collection tank;
b. providing a pipeline segment having a first end and a second end;
c. providing a vacuum line having a first end and a second end;
d. attaching said first end of said vacuum line to said second end of said pipeline segment;
e. attaching said second end of said vacuum line to said collection tank;
f. inserting a compressible pig into said first end of said pipeline;
g. creating a negative pressure in said collection tank thereby creating a negative pressure in said vacuum line and said pipeline segment; and
h. pulling said compressible pig through said pipeline segment toward said collection tank by said negative pressure.

2. The method for cleaning a pipeline recited in claim 1, wherein:
a. said pipeline segment contains unwanted debris; and
b. wherein said step of pulling said compressible pig through said pipeline segment includes pushing said unwanted debris toward said collection tank with said compressible pig.

3. The method for cleaning a pipeline recited in claim 2, further comprising the step of:
a. collecting said unwanted debris in said collection tank; and
b. delivering said unwanted debris from said collection tank to a storage container.

4. The method as recited in claim 3, wherein said collection tank is positioned on a floating vessel.

5. The method as recited in claim 3, wherein said compressible pig has a diameter larger than said pipeline said pipeline diameter.

6. The method as recited in claim 5 further comprising the additional step of pushing said pig toward said collection tank by a positive pressure in said pipeline behind said pig.

7. The method as recited in claim 6 further comprising the steps of:
a. measuring pressure changes in said collection; and
b. determining whether said pressure changes are caused by a leak in said pipeline.

8. The method as recited in claim 7, including the additional step of pulling said compressible pig into and through said vacuum line into said collection tank.

9. The method as recited in claim 7, wherein said unwanted debris includes transient fluids and hydrocarbons.

10. The method as recited in claim 9, wherein the said step of creating a vacuum in said collection tank includes creating said vacuum with a pump.

11. method as recited in claim 10 including the additional steps of delivering said transient fluids and hydrocarbons from said collection tank to said storage container by means of a pump.

12. An pipeline cleaning apparatus comprising:
a. a vacuum assembly;
b. a pipeline segment having a first end and a second end;
c. a temporary vacuum line haying a first connection inlet attached to said vacuum assembly and a second connection inlet attached to said second end of said pipeline segment; and
d. a compressible. cleaning pig inserted into said first end of said pipeline segment thereby sealing said pipeline segment.

13. The pipeline cleaning apparatus recited in claim 12 wherein said compressible pig has a diameter greater than the diameter of said pipeline.

14. The pipeline cleaning apparatus recited in claim 13 wherein said vacuum assembly includes:
a. a vacuum chamber in communication with a vacuum pump;
b. a debris collection tank;
c. a suction line in communication with said collection tank and said vacuum chamber; and
d. a suction inlet line in communication with said collection tank and said temporary vacuum line.

15. The pipeline cleaning apparatus recited in claim 14, further comprising:
a. a discharge outlet line from said collection tank;
b. a discharge pump in communication with said discharge outlet line; and
c. a storage container.

16. The pipeline cleaning apparatus recited in claim 14, wherein said vacuum assembly is positioned on a floating vessel.

17. A method for cleaning a pipeline comprising the steps of:
a. providing, a collection tank;
b. providing a pipeline segment containing unwanted debris;
c. providing a vacuum line between said collection tank and said pipeline segment;
d. inserting a compressible pig into said pipeline segment;
e. creating a negative pressure in said collection tank thereby creating a negative pressure in said vacuum line and said pipeline segment whereby said compressible pig is pulled through said pipeline segment so as to push said unwanted debris toward said collection tank.

18. The method as recited in claim 17 wherein the interior walls of said pipeline segment are scraped with said compressible pig.

19. The method as recited in claim 18 further comprising the steps of:
a. collecting said unwanted debris in said collection tank; and
b. delivering said unwanted debris from said collection tank to a storage container.

20. The method as recited in claim 19 wherein said unwanted debris includes transient fluids and hydrocarbons.
